(19) United States
(12) Patent Application Publication
(10) Pub. No.: US 2010/0005225 A1
(43) Pub. Date: Jan. 7, 2010

(54) NONVOLATILE MEMORY DEVICE, NONVOLATILE MEMORY SYSTEM, AND HOST DEVICE

(75) Inventors: Toshiyuki Honda, Kyoto (JP); Masahiro Nakanishi, Kyoto (JP); Takuji Maeda, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/374,671

(22) PCT Filed: Jul. 26, 2007
(86) PCT No.: PCT/JP2007/064676

§ 371 Date: Mar. 19, 2009

(30) Foreign Application Priority Data
Jul. 26, 2006 (JP) 2006-203535

(51) Int. Cl. G06F 12/00; G06F 12/02

(52) U.S. Cl. 711/103; 707/205; 707/E17.01; 711/E12.001; 711/E12.008

(57) ABSTRACT

A nonvolatile memory device has a file system manager and manages the file system of a file to be recorded. The nonvolatile memory device measures time by obtaining time information from outside in each writing file data or based on time information preliminarily obtained. At the time of writing file data, management information of the file system is configured based on the time information at the time. Thus, the time information can be stored in a file entry table, and the time information can be used as file management information. The nonvolatile memory system with high user's convenience can be provided.

### TECHNICAL FIELD

The present invention relates to a nonvolatile memory device, nonvolatile memory system, and host device characterized by management of files and management of a file system structure in data writing to a memory device using a nonvolatile memory such as a memory card.

### BACKGROUND ART

In these years, a memory card mounting a flash memory that is a nonvolatile memory extends its market as a memory medium for a digital still camera and mobile phone. The number of files able to be recorded in the memory card increases with an increase of a capacity of the memory card. Hence, a host device has an increased capacity of FAT file system information required to handle the memory card. Details of the FAT file system are described in a conventional technique of Patent document 1. Patent document 1 shows that a table size becomes huge with the increase of the capacity of the memory card and the table becomes hard to be handled when a host manages data writing and data reading to the memory card (memory medium) with a large capacity by using the FAT file system, and that makes a suggestion to improve performance of the data writing and reading by using a file system other than the FAT file system.

Patent document 2 shows, as a problem, that transfer of the FAT file system information between the memory card and a host device increases with the increase of the FAT file system information increases, and thus performance deterioration of data writing and reading (not including the FAT file system information) occurs. In Patent document 2, a memory controller is installed in the memory card and the memory controller manages a file system structure based on the FAT file system information. Suggested is a memory card which reduces the transfer of the FAT file system information between the memory card and the host device on the basis of this manner and is prevented from the performance deterioration of data writing and reading.

A data writing method of a nonvolatile memory device in a case where the memory controller manages the file system structure as in Patent document 2 will be briefly explained.

FIG. 1 shows configurations of a memory card, a conventional nonvolatile memory device, and of a host device. A memory card 10 is a memory system which allows a host device 11 to read and write data. The memory card 10 includes a memory controller 12 for control and a nonvolatile memory 13. The memory controller 12 controls the data writing and reading on the nonvolatile memory 13 and controls interface with the host device 11. The nonvolatile memory 13 is a nonvolatile memory which stores data written and read by the host device 11, and is composed of a NAND flash memory.

The memory card 10 is configured so as to be attached and removed to and from the host device 11. Since the memory card 10 is the nonvolatile memory device, data recorded in the nonvolatile memory 13 is not lost even in a state where the memory card is removed from the host device 11 and an electric voltage is not supplied to. The memory card does not have a power supply source, for example, a backup battery for retaining data because the memory card does not consume the electric power in the state. Meanwhile, the host device 11 has a backup battery for operating a clock function and manages time information.

The memory controller 12 manages a file system structure of data recorded in the nonvolatile memory 13, and the memory controller 12 also generates management information necessary to configure the file system structure and records them in the nonvolatile memory 13. When reading and writing data from and into the memory card 10, the host device 11 does not read and write data by specifying an address but reads and writes data from and into the memory card 10 by specifying a file.

FIG. 2 shows a flowchart of writing of data from the host device 11. When writing data into the memory card 10, the host device 11 firstly informs the memory card 10 of a file name and file size of data to be written at step S01. When receiving a response of permission for the writing from the memory card 10, the host device 11 writes data by transferring file data to the memory card 10 at step S02.

Patent document 1: Japanese Unexamined Patent Publication No. 2004-13276

Patent document 2: Japanese Unexamined Patent Publication No. 2003-187203

### DISCLOSURE OF THE INVENTION

### Problems to be Solved by the Invention

When a file system structure is managed on the memory card side as shown in Patent document 2, transfer of file system information between a memory card and a host device is not required, thus resulting in prevention of performance deterioration. The memory card originally used as a nonvolatile memory device does not include a battery internally and does not require electric power at all unless the memory card is connected to the host device and an electric voltage is supplied to. Since the memory card does not have a clock function internally because of this, management information based on time such as “creation date and time” and “update date and time” cannot be recorded. The creation date, one of metadata of a file, is unclear, hence there is a problem that user's convenience in handling the file is low.

The present invention intends to realize that the nonvolatile memory device can write the time information as management information of the file system and intends to provide a nonvolatile memory device and host device which are highly convenient for users and a nonvolatile memory system including them.

### Means to Solve the Problems

To solve the problems, a nonvolatile memory device of the present invention comprises: a memory controller; and a nonvolatile memory and which writes a file given from an external host device into said nonvolatile memory and reads a specified file, wherein said memory controller comprises: a clock part to which an initial value of time information is provided from outside and which measures time only for a period when a power is supplied; a file system manager for generating file management information including the time information measured by said clock part in writing of a file; and a control part for writing the file management information generated by said file system manager and files into said nonvolatile memory.

The initial value of said time information set to the clock part of said memory controller may be provided from said host device.

To solve the problems, a nonvolatile memory device of the present invention comprises: a memory controller; and a nonvolatile memory and which writes a file given from an external host device into said nonvolatile memory and reads a specified file, wherein said memory controller comprises: a file system manager for generating file management information including the time information given from outside of said nonvolatile memory device in writing of a file; and a control part for writing the file management information generated by said file system manager and files into said nonvolatile memory.

Said memory controller may obtain said time information from said host device in each said writing of a file from said host device.

Said memory controller may have a wireless communication part for obtaining said time information by using a wireless communication, and said clock part may set the time information obtained by said wireless communication part.

Said memory controller may have a receiving part for obtaining said time information by receiving the time calibration signal, and said clock part may set the time information obtained by said wireless communication part.

Said nonvolatile memory may be composed of a flash memory.

Said nonvolatile memory may be composed of a hard disk drive.

To solve the problems, a nonvolatile memory system of the present invention comprises: a host device, and a nonvolatile memory device which writes a file given from said host device and reads a specified file, wherein said nonvolatile memory device comprises: a memory controller; and a nonvolatile memory, and said memory controller comprises: a clock part to which an initial value of time information is provided from outside and which measures time only for a period when a power is supplied; a file system manager for generating file management information including the time information measured by said clock part in writing of a file; and a control part for writing the file information including management information generated by said file system manager into said nonvolatile memory.

To solve the problems, a nonvolatile memory system of the present invention comprises: a host device, and a nonvolatile memory device which writes a file given from said host device and reads a specified file, wherein said nonvolatile memory device comprises: a memory controller; and a nonvolatile memory, and said memory controller comprises: a file system manager for generating file management information including the time information given from outside of said nonvolatile memory device in file writing; and a control part for writing the file management information generated by said file system manager and files into said nonvolatile memory.

To solve the problems, a host device of the present invention applying an electric voltage to a nonvolatile memory device and reading and writing a file informs said nonvolatile memory device of file data and the time information respectively in writing of a file.

### EFFECTIVENESS OF THE INVENTION

According to the present invention, the nonvolatile memory device managing the file system structure can write the time information as management information of the file system by obtaining the time information from outside of the nonvolatile memory device. Therefore, the present invention is able to provide the nonvolatile memory device, host device, and host device including them, which are able to use the time information as management information of a file and are highly convenient for users.

### BRIEF DESCRIPTION OF DRAWINGS

FIG. 1 is a view showing a configuration of a memory card and host device of a conventional nonvolatile memory device.

FIG. 2 is a flowchart of writing of data from the host device in the conventional nonvolatile memory device.

FIG. 3 is a view showing a configuration of a memory card and host device of a nonvolatile memory system in a first embodiment of the present invention.

FIG. 4 is a view showing a configuration of a file entry table in the embodiment.

FIG. 5 is a view showing a field configuration of a record in the file entry table in the embodiment.

FIG. 6 is a flowchart of writing of data from the host device of the nonvolatile memory system in the first embodiment of the present invention.

FIG. 7 is a view of sequence in data writing between the host device and the memory card of the nonvolatile memory system in the first embodiment of the present invention.

FIG. 8 is a view of sequence in data writing between a host device and a memory card showing a modified example of the nonvolatile memory system in the embodiment of the present invention.

FIG. 9 is a view showing a configuration of a memory card and host device of a nonvolatile memory system in a second embodiment of the present invention.

FIG. 10 is a flowchart in applying voltage to the memory card from the host device of the nonvolatile memory system in the second embodiment of the present invention.

FIG. 11 is a flowchart of writing of data from the host device of the nonvolatile memory system in the second embodiment of the present invention.

FIG. 12 is a view of sequence in data writing between the host device and the memory card of the nonvolatile memory system in the second embodiment of the present invention.

FIG. 13A is a view showing a configuration of a nonvolatile memory system according to a third embodiment of the present invention.

FIG. 13B is a block diagram showing a configuration of a wireless host device according to the third embodiment of the present invention.

FIG. 14 is a block diagram showing a configuration of a nonvolatile memory system according to a fourth embodiment of the present invention.

FIG. 15 is a block diagram showing a configuration of a nonvolatile memory system according to a fifth embodiment of the present invention.

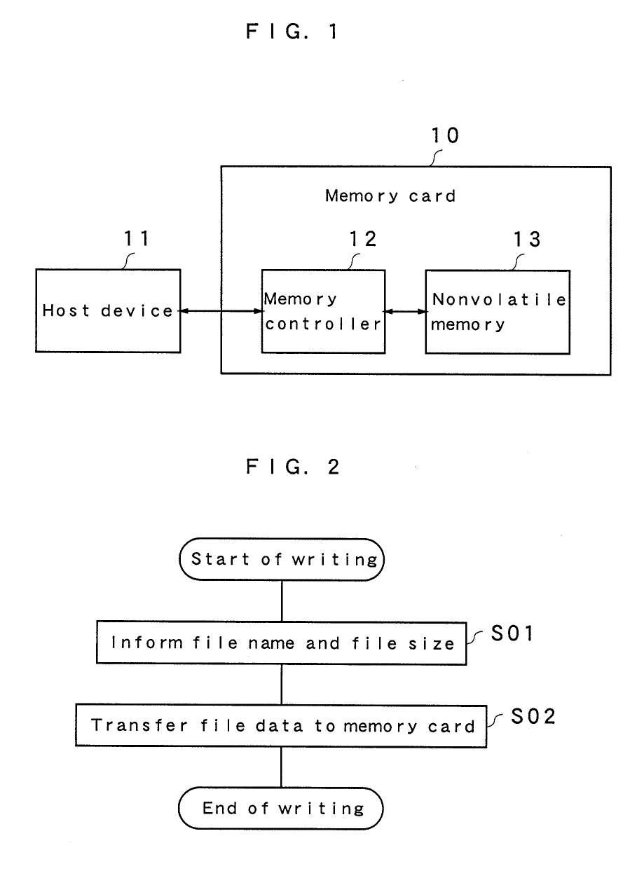

### EXPLANATION FOR REFERENCE NUMERALS

100A, 100B, 100C, 100D, 100E Memory card
200A, 200B, 200C Host device
110A, 110B, 110C, 110D, 110E Memory controller
111 Memory card processor
112 Host IF
113 Memory device IF
114 Buffer memory
115 Logical-physical conversion table
116 File system manager
117 Time information retainer
118 Clock part
119 Clock manager
120 Wireless host IF
121 Time calibration signal receiver
122 NPTIF
130 Nonvolatile memory
210 Host processor
220 Clock part
221 Battery
230 Memory card IF
231 File information access part
232 File data access part
233, 236, 237 Time notification part
234 Card initialization part
235 Card state detector
300 Wireless host device
310 Wireless IF

### BEST MODE FOR CARRYING OUT THE INVENTION

### First Embodiment

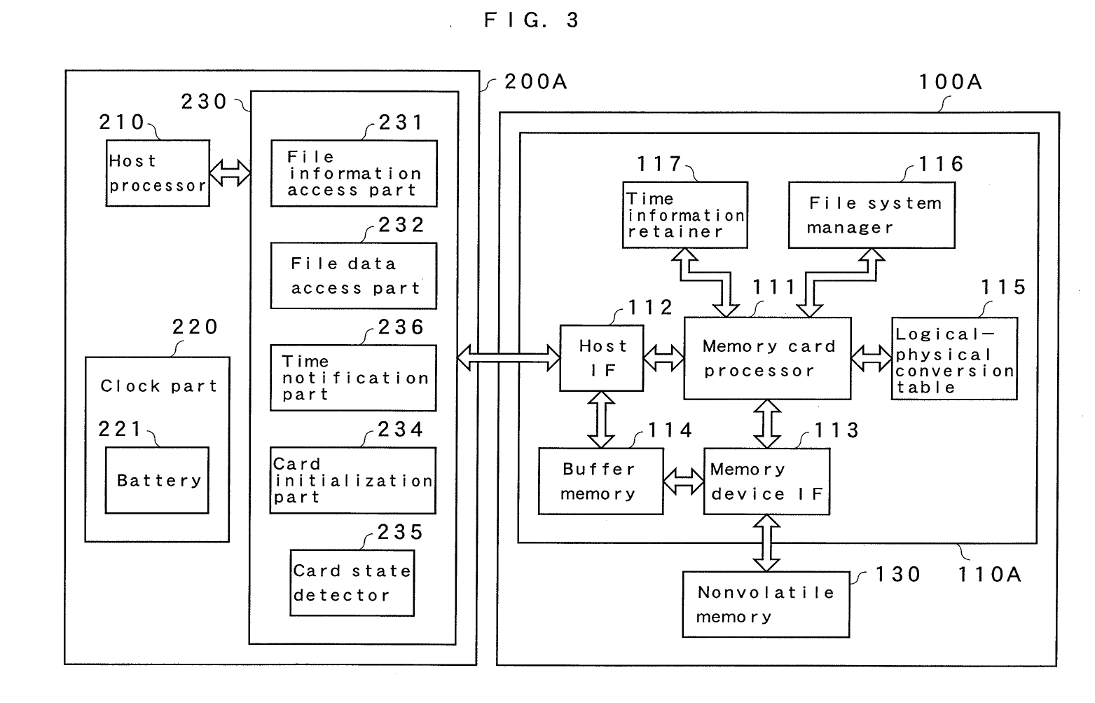

Referring to attached figures, a first embodiment of the present invention will be explained below. FIG. 3 shows a configuration of a memory card and a host device which are one embodiment of a nonvolatile memory device of the present invention. A memory card 100A is a nonvolatile memory device from and to which a host device 200A can read and write data. The memory card 100A includes a memory controller 110A for control and a nonvolatile memory 130. The memory controller 110A controls the nonvolatile memory 130 on data writing and reading and controls interface with the host device 200A.

The memory controller 110A includes a memory card processor 111, host interface (IF) 112, memory device IF 113, buffer memory 114, logical-physical conversion table 115, file system manager 116, and time information retainer 117. The memory card processor part 111 controls the whole memory card. The host IF 112 controls interface with the host device 200A, and the memory device IF controls interface with the nonvolatile memory 130. The buffer memory 114 temporarily stores data written into the memory card by the host device and temporarily stores data read from the nonvolatile memory 130. The logical-physical conversion table 115 is a table for managing a correspondence relation between logical addresses that the file system manager 116 specifies to the memory card processor part 111 and physical addresses of the nonvolatile memory 130. The file system manager 116 manages, in units of files, data that is written and read by the host device 200, and generates file management information necessary to configure a file system structure. The time information retainer 117 retains the time information given from the host device. The memory card processor 111, memory device IF 113, buffer memory 114, and logical-physical conversion table 115 constitute a control part for writing the file management information generated in writing of file data by the file system manager 116 and for writing the file data into the nonvolatile memory.

The nonvolatile memory 130 is a nonvolatile memory for storing data written by the host device 200A, and is composed of, for example, a NAND flash memory.

The memory card 100A is configured so as to be attachable and detachable to and from the host device 200A. Since the memory card 100A is the nonvolatile memory device, data recorded in the nonvolatile memory 130 is never lost in a state where the memory card is detached from the host device 200A and the electric voltage is not applied to the memory card 100A at all. In addition, not consuming the electric power in that state, the configuration does not have an electric voltage supply source, for example, a backup battery for retaining data.

Next, the host device 200A will be explained. The host device 200A includes a host processor 210, a clock part 220, and a memory card IF 230. The host processor 210 controls the whole host device and controls the memory card 100A on writing and reading of the files. The clock part 220 internally includes a battery 221 and manages the time information, to which an electric voltage is constantly supplied from the battery 221 to work its clock function. The memory card IF 230 controls interface with the memory card 100A in accordance with directions of the host processor 210, and has a file information access part 231, a file data access part 232, a time notification part 233, a card initialization part 234, and a card state detector 235.

The file information access part 231 specifies a name and size of a file to be written to the memory card 100A, obtains file information such as a list of the file names, attributes and the creation time of the files, and file sizes, and assigns a directory location in the file system structure of the memory card. The file data access part 232 controls file data to be written and read to and from the memory card 10A, the time notification part 233 obtains the time information from the clock part 220 in writing of file data and gives the time information to the memory card 100A. The card initialization part 234 initializes the memory card 100A in accordance with a direction of the host processor 210. The initialization includes setting of an operating voltage, setting of an operating frequency, and setting of a bus width of the interface. In addition, the card state detector 235 detects that the attachable memory card 100A has been attached to or detached from the host device 200A, and informs the host processor 210 of it.

The memory controller 110A manages the file system structure of data to be recorded in the nonvolatile memory 130. Accordingly, when reading and writing data from and into the memory card 100A, the host device 200A does not read and write data by specifying an address but read and write data by specifying a file.

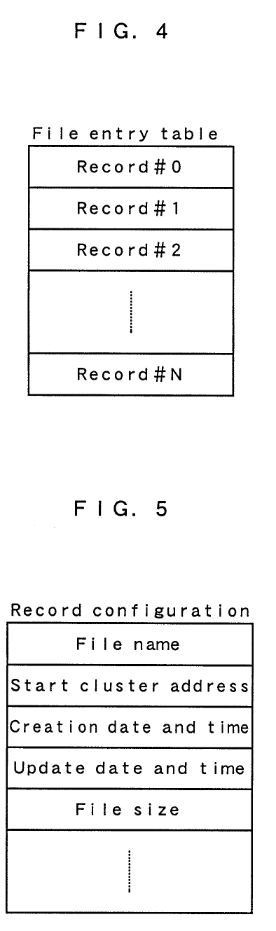

As one of data necessary to configure the file system structure, there is a file entry table shown in FIG. 4. The file entry table corresponds to a root directory entry and a sub directory entry in the FAT file system. The file entry table is a table representing a list of files belonging in a certain management unit, as 1 file is equivalent to 1 record. One record stores the management information of one file.

FIG. 5 shows one example of internal information of respective records. The internal information includes fields such as a “file name”, “start cluster address”, “creation date and time”, “update date and time”, and “file size”.

Since the file system manager 116 of the memory controller 110A generates the management information necessary to configure a file and records the information into the nonvolatile memory 130, the information of the record configuration shown in FIG. 5 is not directly given from the host device 200A. The memory controller 110A itself generates the information based on information for controlling the nonvolatile memory 130 stored in a volatile RAM, and writes the generated information into the nonvolatile memory 130.

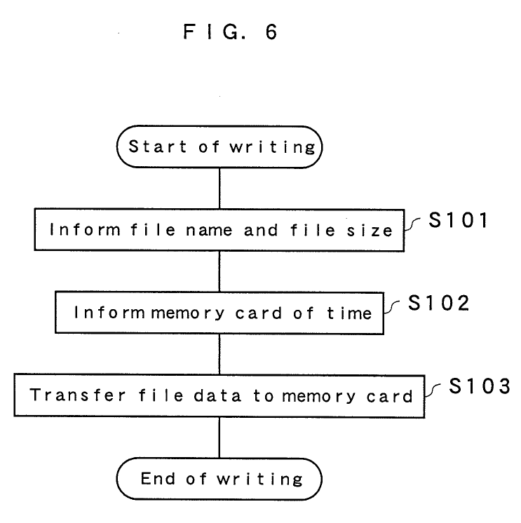

FIG. 6 shows a flowchart of writing of data in the host device 200A. When the host device 200A writes data to the memory card 100A, the host device 200A firstly informs the memory controller 110A of the memory card 100A of a file name and file size of data to be written at step S101. Next, the time notification part 233 of the host device 200A informs the memory card 100A of time information of the clock part 220 at step S102. Lastly, the file data access part 232 of the host device 200A transfers the file data to the memory card 100A at step S103.

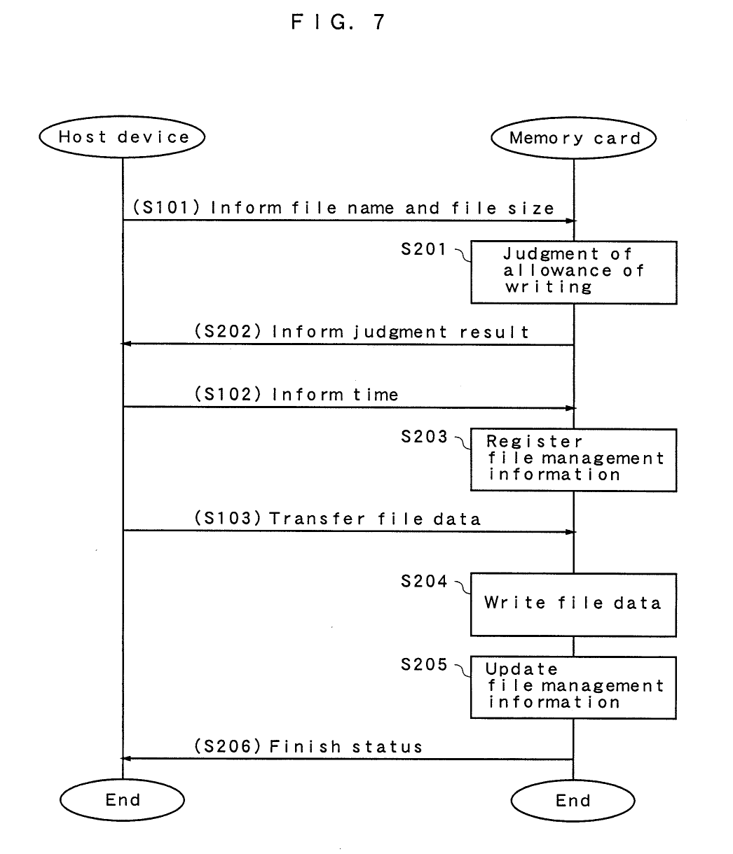

FIG. 7 shows a view of sequence between the host device 200A and the memory card 100A corresponding to this data writing. When the host device 200A writes data into the memory card 100A, the host device 200A firstly informs the memory card 100A of a file name and file size of data to be written at step S101. Meanwhile, the memory controller 110A receives them via the host IF 112, analyzes, at step S201, the file system structure that the memory controller manages by itself, and judges whether it is possible to write the file required by the host device 200A or not. In this judgment, after comparing a capacity of a free area obtained from the analyzed file system structure with the file size to be written presented at step S101, the memory controller judges that the file can be written when the capacity of the free area is equal to or larger than the file size. The controller, on the contrary, judges that the file cannot be written when the capacity of the free area is smaller than the file size. The memory controller subsequently returns the judgment result of the writing to the host device 200A (S202). Assuming here that the file can be written, continuing processing will be explained.

When obtaining the result showing a file can be written from the memory card 100A, the host device 200A informs the memory card 100A of the time information of the clock part 220 operating in the host device 200A via the time notification part 233 (S102). The informed time information is temporarily stored in the time information retainer 117.

In response to this, the memory controller 110A registers the file management information, namely the directory entry in the FAT file system into the nonvolatile memory 130 at step S203. Specifically, one of the records in the file entry table in FIG. 4 is updated to new information and is written into the memory. The memory controller 110A writes file name represented by the host device 200A at step S101 to the “file name” field, and writes a leading address in cluster addresses where data is to be written to the “start cluster address” field. The memory controller 110A writes a capacity 0 to the “file size” field since the data has not been written yet. The memory controller 110A writes the time information informed at step S102 by the host device 200A to the “creation date and time” field.

After informing time, the host device 200A transfers data of a file to the memory card 100A at step S103. The memory controller 110A writes the transferred data into the nonvolatile memory 130 (S204). The processings at step S103 and step S204 are executed more than once until the host device 200A finishes the transferring of data of the file size to the memory card 100A. On this occasion, the memory controller 110A updates the file management information and updates the FAT in the FAT file system as necessary.

After the transferring of the data of the file size has been finished and all of the data have been written into the nonvolatile memory 130, the file system manager 116 updates the file management information as step S205. In this update, a size of the presently written file data is written into the “file size” field. This size is the same as the size informed at step S101 by the host device 200A. After completely finishing the writing to the nonvolatile memory 130, the memory controller 110A finishes the series of the writing processing by returning a finish status at step S206 to the host device 200A.

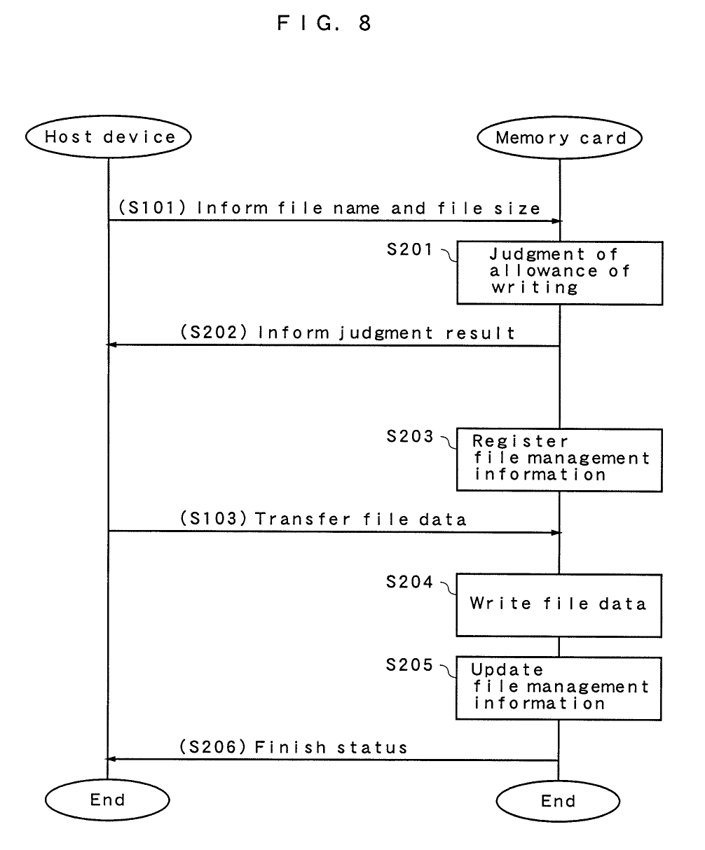

In this embodiment, the file name and file size, and the time are independently informed as shown at steps S101 and 102 in FIG. 7, however, they may be simultaneously informed to the memory card 100A side at step S101 as shown in FIG. 8.

When the time information relating to a file to be written is informed by the host device 200A as described above, the time information can be recorded into the file management information even when the memory card 100A does not have the clock function. As a result, the time information can be used as the management information of files, and a nonvolatile memory device and host device which are highly convenient for users and a nonvolatile memory system including them can be provided.

### Second Embodiment

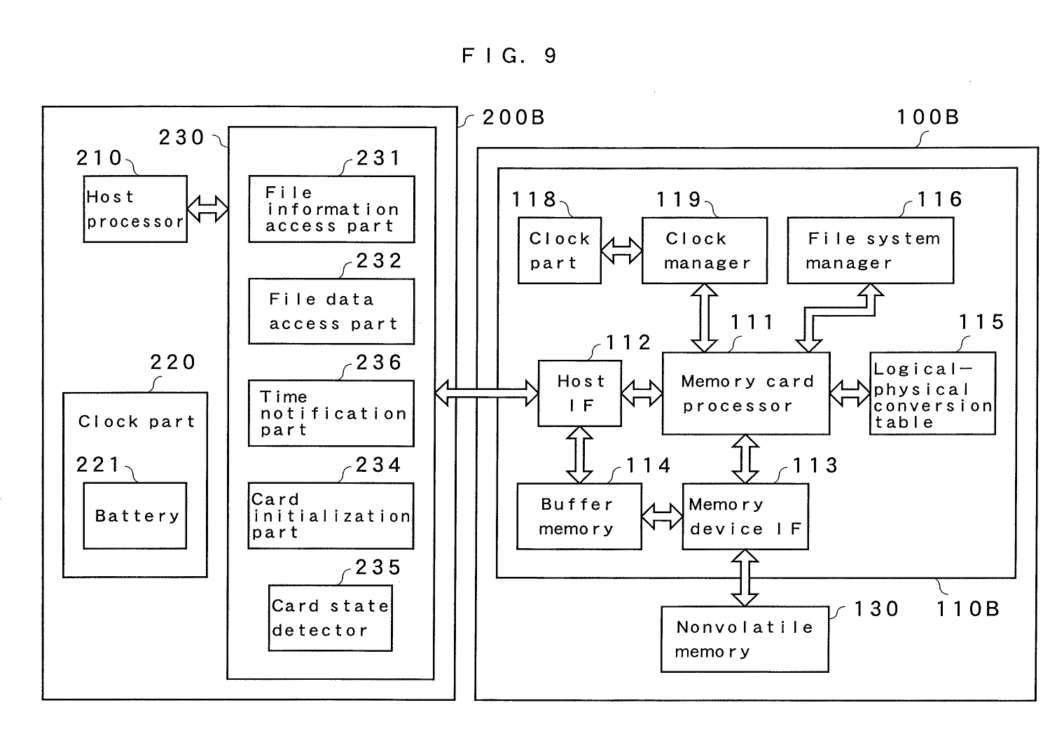

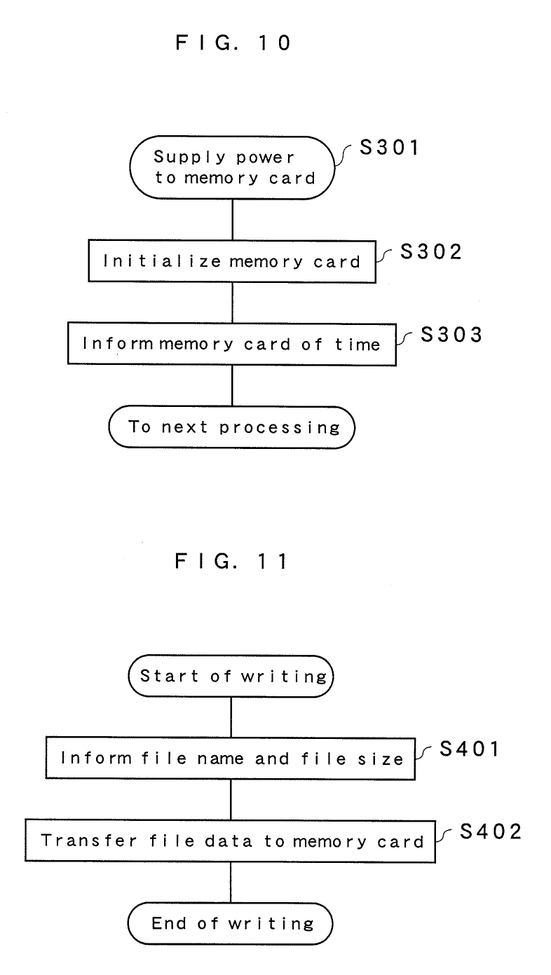

A second embodiment of the present invention will be explained. FIG. 9 shows a configuration of a memory card and a host device which are one embodiment of a nonvolatile memory device of the present invention. The identical numerals are given to the same parts in this embodiment as those in the first embodiment, and a detailed explanation will be omitted. A memory card 100B is a nonvolatile memory device from and to which a host device 200B can read and write data. A memory controller 110B of the memory card 100B has a clock part 118 and clock manager 119 instead of the time information retainer 117. The clock part 118 measures time based time information set by outside only for a period when a power is supplied. The clock manager 119 sets time to the clock part 118, and reads the time information retained in the clock part 118. Other components are the same as those of the above mentioned first embodiment.

The host device 200B has the host processor 210 and the memory IF 230 same as the above mentioned first embodiment. A time notification part 236 of the memory IF 230 indicates the time information to the memory card side when an electric voltage is supplied to the memory card 100B. Other components are the same as those of the above mentioned embodiment.

Since the data necessary to configure the file system structure is also the same as that explained in the first embodiment, the explanation will be omitted here.

The memory controller 110B generates the management information necessary to configure the file system structure and records the information into the nonvolatile memory 130 same as the first embodiment. The information of the record configuration shown in FIG. 5 is not directly given from the host device 200B, and the memory controller 110B itself generates the information based on information stored in a volatile RAM for controlling the nonvolatile memory 130 and writes the generated information into the nonvolatile memory 130.

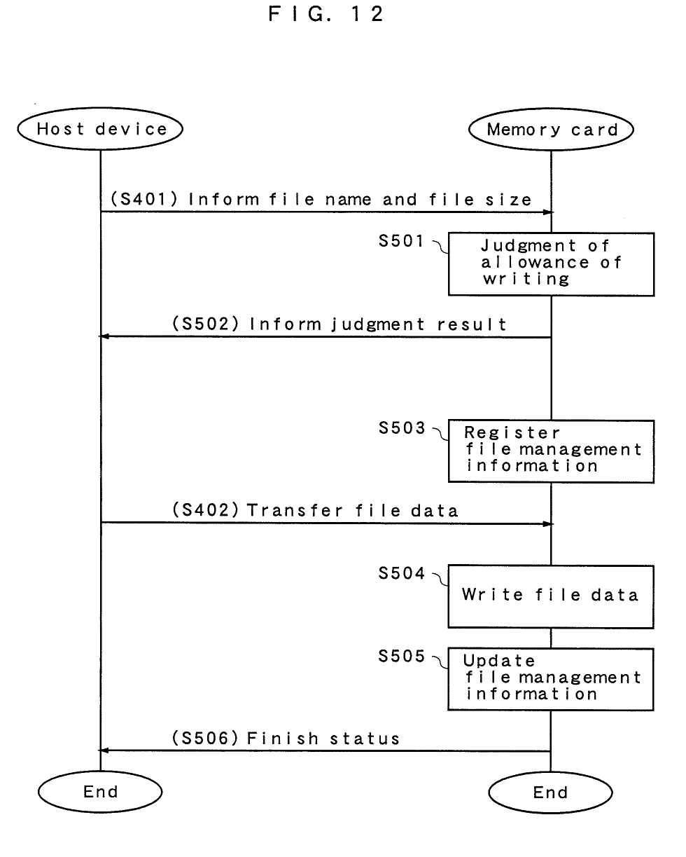

Processing for informing the time information from the host device 200B to the memory card 100B will be explained by using a flowchart of FIG. 10. Step S301 is a step for starting an operation of the memory card 100 by supplying power to the memory card. When the memory card 100B is connected to the host device 200B and the host device 200B applies the electric voltage to the memory card 100B, the operation starts. Even when the memory card 100B is connected to the host device 200B, there is a case where the electric voltage is not supplied to the connecting memory card 100B due to a convenience of the host device 200B such as reduction of the power consumption. When the host device 200B applies the electric voltage to the memory card 100B again in this state, the operation starts and the processing is transferred to step S302. While the electric voltage is not supplied to the memory card 100B, the operation does not start.

The card initialization part 234 of the host device 200B initializes the memory card 100B at step S302. The host device 200B obtains the time information from the clock part 220 at step S303 and informs the memory card 100B of the time information via the time notification part 236.

In the memory card 100B, the clock manager 119 sets the time information informed at step S303 to the clock part 118. The clock part 118 subsequently measures time as far as the electric voltage is supplied from the host device 200B to the memory card 100B, and the clock part 118 gives the time information every time when the memory card processor 111 writes the management information into the nonvolatile memory 130.

Here, explained is a case where the time information is informed only once after the initialization of the memory card 100B, however, the host device 200B may inform the memory card 100B of the time information again as necessary in order to prevent deviation of the time information. For example, a method for informing the time information again after a certain time has passed from the previous informing can be considered.

FIG. 11 is a flowchart of a case where the host device 200B writes data. When the host device 200B writes data to the memory card 100B, the host device 200B firstly informs the memory controller 110B of the memory card 100B of a file name and file size of data to be written at step S401. Next, the host device 200B writes data by transferring the file data to the memory card 100B at step S402.

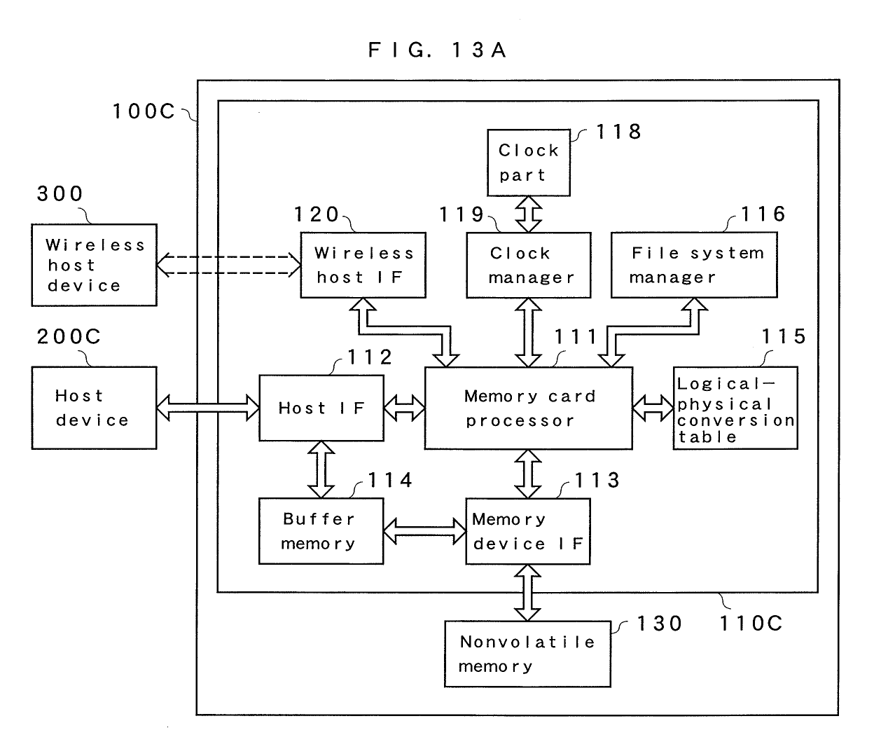

FIG. 12 shows a view of sequence between the host device 200B and the memory card 100B in a case where the host device 200B side writes data. When the host device 200B writes data into the memory card 100B, the host device 200B firstly informs the memory card 100B of a file name and file size of data to be written at step S401.

Next, the memory controller 110B analyzes, at step 501, the file system structure that the memory controller manages by itself, and judges whether or not writing of a file required by the host device 200B is possible. After comparing a capacity of a free area obtained from the presently analyzed file system structure with a capacity of a presented size of the file to be written, the memory controller judges that the file can be written when the free area has the file size or more and, on the contrary, judges that the file cannot be written when the free area is smaller than the file size (S501). The memory controller subsequently returns the judgment result of the writing to the host device 200B. Assuming here that a file can be written, continuing processing will be explained.

The memory controller 110B registers the directory entry in the file management information, namely, the FAT file system into the nonvolatile memory 130 at step S503. Specifically, the memory controller 110B updates one of the records in the file entry table in FIG. 4 to new information and writes into the memory. The memory controller 110B writes the file name represented by the host device 200B into the “file name” field, and a leading address in cluster addresses where data is to be written is written into the “start cluster address” field. The memory controller 110B writes a capacity 0 into the “file size” field since the data has not been written yet. The memory controller 110B writes time that has been measured by the clock part 118 into the “creation date and time” field.

The host device 202 transfers the file data to the memory card 100B at step S402. The memory controller 110B writes the transferred data into the nonvolatile memory 130 at step S504. The processings at step S402 and step S504 are executed more than once until the host device 200B finishes the transferring of data of the file size to the memory card 100B. On this occasion, the memory controller 110B updates the file management information and updates the FAT in the FAT file system if necessary.

After the transferring the data of the file size has been finished and all of the data have been written into the nonvolatile memory 130, the file system manager 116 updates the file management information as step S505, and writes a size of the presently written file data into the “file size” field. This size is the same as the size informed by the host device 200B. After completely finishing the writing to the nonvolatile memory 130, the memory controller 110B finishes the series of the writing processing by returning an end status at step S506 to the host device 200B.

As described above, the host device 200B informs time information after applying the electric voltage to the memory card 100B, and thereby the memory card 100B can measure time by using the internal clock part 118 and can record the time information into the file management information. The time information can be used as the management information of files, and thereby the present embodiment can provide a highly convenient nonvolatile memory device, a host device, and a nonvolatile memory system including them for users.

### Third Embodiment

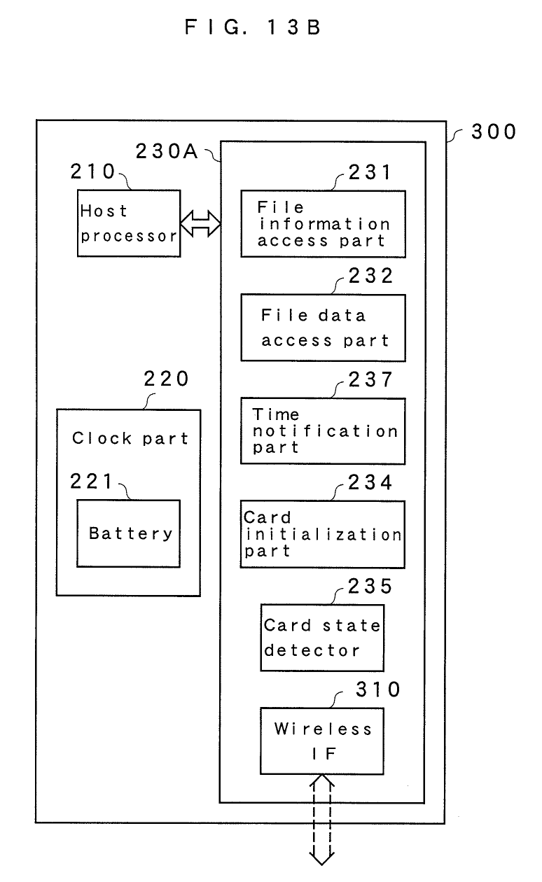

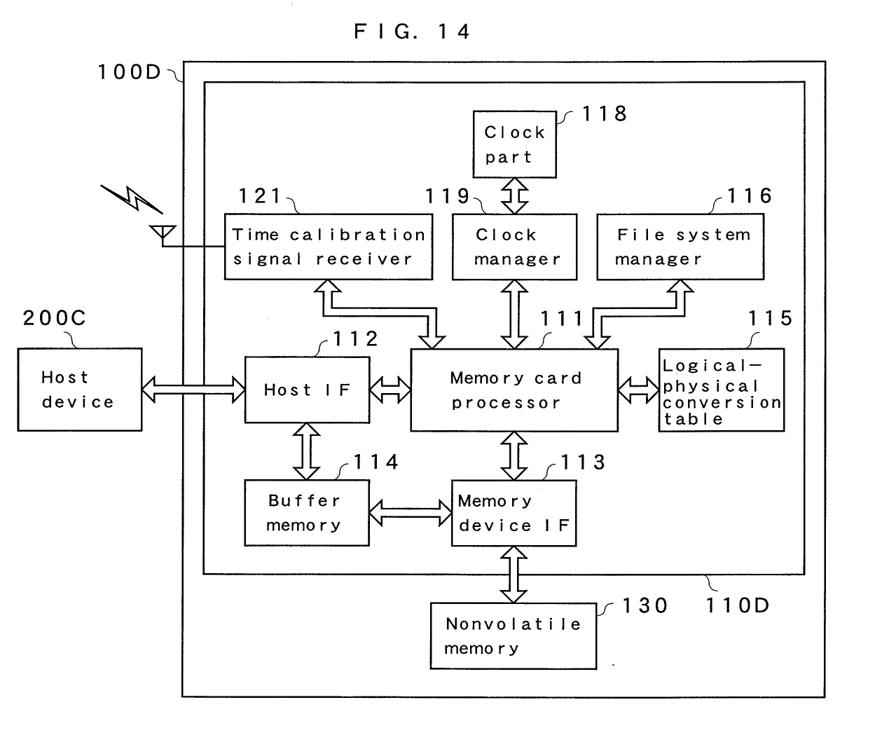

Both of the first and second embodiments employ a configuration where a host device informs the time information to a memory card, and thus the memory card was passive as for obtaining of the time information. However, when the memory card obtains the time information from outside, the present invention can obtain effective configuration even when the memory card actively requests the time information for the outside. FIG. 13A is a view showing a nonvolatile memory system according to a third embodiment, the identical numerals are given to the same parts in this embodiment as those in above mentioned embodiments, and a detailed explanation will be omitted.

In this embodiment, the memory system includes a wireless host device 300 in addition to a host device 200C and memory card 100C, and the memory card 100C obtains the time information from the wireless host device 300. A memory controller 110C of the memory card 100C includes a wireless host IF 120 in addition to the configuration of the memory controller according to the second embodiment. The wireless host IF 120 is a wireless communication part for controlling interface with the wireless host device 300.

FIG. 13B shows a configuration of the wireless host device 300. The wireless host device 300 is almost the same as the above mentioned host device 200B, and a wireless IF 310 is added in the memory card IF 230A. The host device outputs the time information and executes a file access to the memory card 100C via the wireless IF 310. A time notification part 237 reads the time information from the clock part 220 when required by the memory card 100C and gives the information to the memory card 100C.

Meanwhile, the host device 200C does not output the time information in each writing a file and output the time information at the initialization as the first embodiment, but simply writes file data and reads a file.

Accordingly, the memory card 100C can request the present time information for the wireless host device 300 at the initialization of the memory card and can set time to the clock part 118. Subsequent operations are the same as those of the above mentioned second embodiment. In addition, the time information may be obtained from the wireless host device 300 in each writing file data as the first embodiment.

### Fourth Embodiment

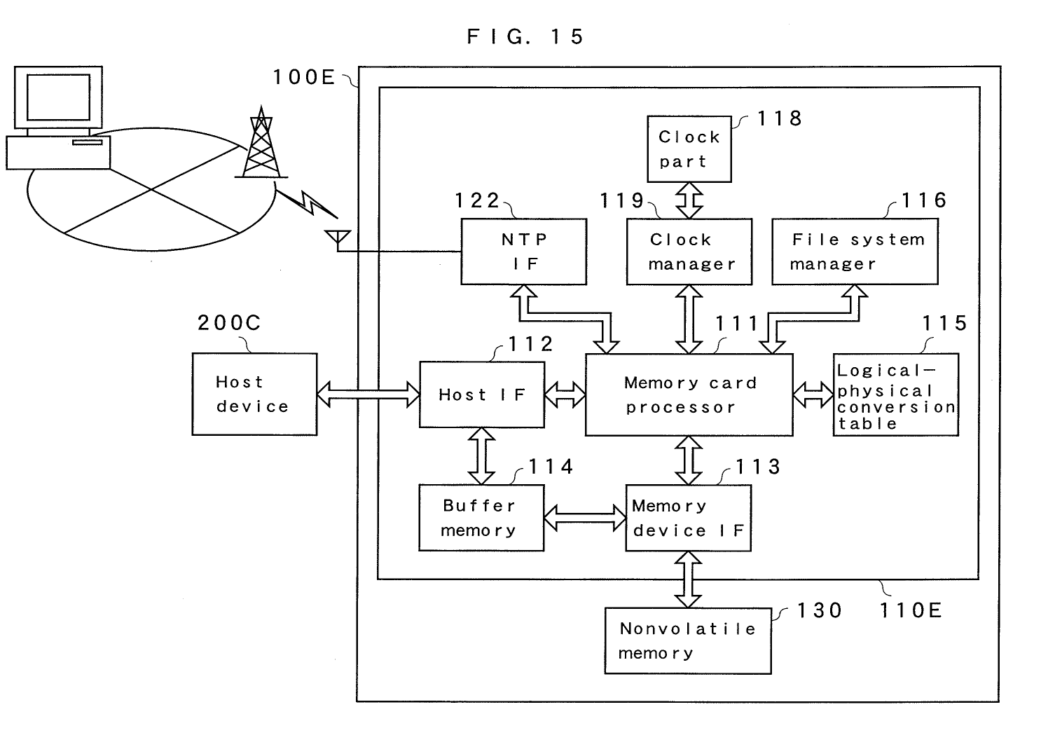

FIG. 14 is a view showing a nonvolatile memory system according to a fourth embodiment of the present invention, and the identical numerals are given to the same parts in this embodiment as those in above mentioned respective embodiments. In this embodiment, a memory controller 110D includes a time calibration signal receiver 121 in addition to the respective blocks of the second embodiment, and sets the time information to the clock part 118 by receiving the time calibration signal including the time information. Subsequent operations are the same as those of the second embodiment. In addition, the time information may be obtained by receiving the time calibration signal in each writing file data as the first embodiment. Furthermore, a wave receiving part for receiving a wave of the GPS including the time information may be provided in stead of the time calibration signal receiver 121, and the time information may be set by the wave receiving part.

### Fifth Embodiment

FIG. 15 is a view showing a nonvolatile memory system according to a fifth embodiment, the identical numerals are given to the same parts in this embodiment as those in above mentioned embodiments, and a detailed explanation will be omitted. In this embodiment, a memory card 100E has a NTPIF (Network Time Protocol Interface) 122 in a memory controller 110E. The NTPIF 122 is a receiving part for obtaining the time information of a server and setting the time information to the clock part 118 of the memory controller 110E. This allows the memory card 100E to connect to an external network such as the internet other than the host device by wireless and to request time for a time server. Subsequent operations are the same as those of the above mentioned second embodiment. In addition, the time information may be obtained from the network in each writing file data as in the first embodiment.

In each of the above described embodiments, the nonvolatile memory device can include the time information in the management information of a recorded file. The device for applying the electric voltage to the memory card, the host device that transfers writing data to the memory card, and the device for giving the time information to the memory card may be different device each other. It can easily realized that, for example, when a host device that writes data by wireless into a memory card connected to a host device simply applying the electric voltage by wire for the memory card exists, the memory card actively obtains the time information based on the time calibration signal after the electric voltage is applied, measures time in the internal clock part, and adds the time information as management information of data written by wireless.

In the embodiments of the present invention, a NAND type flash memory is given as the memory device of the memory card, however, any types of nonvolatile memory devices can also obtain the effectiveness of the present invention. For example, a hard disk drive for magnetically recording, an optical disk, a SRAM backed up by a battery may be employed. Moreover, the memory device may be composed of plural kinds of nonvolatile memory devices. For example, the memory device may be composed of a combination of a semiconductor memory such as the NAND type flash memory and a hard disk.

The controller and the memory card memory device can be also composed of one semiconductor chip when their functions are provided.

### INDUSTRIAL APPLICABILITY

The present invention can be applied to the writing a file in the nonvolatile memory device having the file system, and especially contributes user's convenience in handling the file.

1. A nonvolatile memory device which comprises: a memory controller; and a nonvolatile memory and which writes a file given from an external host device into said nonvolatile memory and reads a specified file, wherein
said memory controller comprises:
a clock part to which an initial value of time information is provided from outside and which measures time only for a period when a power is supplied;
a file system manager for generating file management information including the time information measured by said clock part in writing of a file; and
a control part for writing the file management information generated by said file system manager and files into said nonvolatile memory.

2. The nonvolatile memory device according to claim 1, wherein
the initial value of said time information set to the clock part of said memory controller is provided from said host device.

3. The nonvolatile memory device according to claim 1, wherein
said memory controller has a wireless communication part for obtaining said time information by using a wireless communication, and
said clock part sets the time information obtained by said wireless communication part.

4. The nonvolatile memory device according to claim 1, wherein
said memory controller has a receiving part for obtaining said time information by receiving the time calibration signal, and
said clock part sets the time information obtained by said wireless communication part.

5. The nonvolatile memory device according to claim 1, wherein
said nonvolatile memory is composed of a flash memory.

6. The nonvolatile memory device according to claim 1, wherein
said nonvolatile memory is composed of a hard disk drive.

7. A nonvolatile memory device which comprises: a memory controller; and a nonvolatile memory and which writes a file given from an external host device into said nonvolatile memory and reads a specified file, wherein
said memory controller comprises:
a file system manager for generating file management information including the time information given from outside of said nonvolatile memory device in writing of a file; and
a control part for writing the file management information generated by said file system manager and files into said nonvolatile memory.

8. The nonvolatile memory device according to claim 7, wherein
said memory controller obtains said time information from said host device in each said writing of a file from said host device.

9. The nonvolatile memory device according to claim 7, wherein
said memory controller has a wireless communication part for obtaining said time information by using a wireless communication, and
said clock part sets the time information obtained by said wireless communication part.

10. The nonvolatile memory device according to claim 7, wherein
said memory controller has a receiving part for obtaining said time information by receiving the time calibration signal, and
said clock part sets the time information obtained by said wireless communication part.

11. The nonvolatile memory device according to claim 7, wherein
said nonvolatile memory is composed of a flash memory.

12. The nonvolatile memory device according to claim 7, wherein
said nonvolatile memory is composed of a hard disk drive.

13. A nonvolatile memory system comprising: a host device, and a nonvolatile memory device which writes a file given from said host device and reads a specified file, wherein
said nonvolatile memory device comprises: a memory controller; and a nonvolatile memory, and
said memory controller comprises:
a clock part to which an initial value of time information is provided from outside and which measures time only for a period when a power is supplied;
a file system manager for generating file management information including the time information measured by said clock part in writing of a file; and
a control part for writing the file information including management information generated by said file system manager into said nonvolatile memory.

14. The nonvolatile memory system according to claim 13, wherein
the initial value of said time information set to the clock part of said memory controller is provided from said host device.

15. The nonvolatile memory system according to claim 13, wherein
said memory controller has a wireless communication part for obtaining said time information by using a wireless communication, and
said clock part sets the time information obtained by said wireless communication part.

16. The nonvolatile memory system according to claim 1, wherein
said memory controller has a receiving part for obtaining said time information by receiving the time calibration signal, and
said clock part sets the time information obtained by said wireless communication part.

17. A nonvolatile memory system comprising: a host device, and a nonvolatile memory device which writes a file given from said host device and reads a specified file, wherein
said nonvolatile memory device comprises: a memory controller; and a nonvolatile memory, and
said memory controller comprises:
a file system manager for generating file management information including the time information given from outside of said nonvolatile memory device in file writing; and
a control part for writing the file management information generated by said file system manager and files into said nonvolatile memory.

18. The nonvolatile memory system according to claim 17, wherein
said host device provides said time information to said nonvolatile memory device in said each writing a file, and
said nonvolatile memory device writes the management information including the given time information in said each writing a file from said host device into said nonvolatile memory.

19. The nonvolatile memory system according to claim 17, wherein
said memory controller has a wireless communication part for obtaining said time information by using a wireless communication, and
said clock part sets the time information obtained by said wireless communication part.

20. The nonvolatile memory system according to claim 17, wherein
said memory controller has a receiving part for obtaining said time information by receiving the time calibration signal, and
said clock part sets the time information obtained by said wireless communication part.

21. A host device applying an electric voltage to a nonvolatile memory device and reading and writing a file, wherein said host device informs said nonvolatile memory device of file data and the time information respectively in writing of a file.

22. The host device according to claim 21, which informs said nonvolatile memory device, and informs said memory controller of said time information at least at initialization.

23. The host device according to claim 21, which informs said memory controller of said time information in each said writing of a file.
